(19) United States
(12) Patent Application Publication
(10) Pub. No.: US 2021/0158035 A1
(43) Pub. Date: May 27, 2021

(54) SYSTEM, METHOD AND COMPUTER PROGRAM PRODUCT FOR AUTOMATIC REMOTE VERIFICATION OF IDENTITY DOCUMENTS

(71) Applicant: AU10TIX LTD., Hod Hasharon (IL)

(72) Inventors: Benjamin NEEMAN, Raanana (IL); Sergey MARKIN, Herzeliya (IL); Ron ATZMON, Tel Aviv (IL)

(73) Assignee: AU10TIX LTD., Hod Hasharon (IL)

(21) Appl. No.: 17/101,515

(22) Filed: Nov. 23, 2020

Related U.S. Application Data
(60) Provisional application No. 62/938,348, filed on Nov. 21, 2019.

(51) Int. Cl. G06K 9/00; G06N 3/04; G06K 9/62; B42D 25/30

(52) U.S. Cl. CPC G06K 9/00456; G06N 3/04; B42D 25/30; G06K 9/6259; G06K 9/6262

(57) ABSTRACT

System differentiating “legitimate” images generated by scanning physical documents from “forged” document images, the system comprising a trained classifier, configured to sort a stream of incoming images into two classes including a first (“legitimate”) class of images generated by scanning physical documents; and a second (“forged”) class of images including images at least partly generated by a graphics editor rather than by scanning a physical document; and an output device operative to present, to an end-user, an output identifying, for at least one image I, whether said image I belongs to said first class or said second class; and an output device configured, responsive to classifications generated by the trained classifier, to provide an output indication of whether each of a plurality of images is generated by scanning a physical document, or is at least partly generated by a graphics editor.

### REFERENCE TO CO-PENDING APPLICATIONS

Priority is claimed from United States Provisional Patent Application No. 62/938,348 entitled “System, method and computer program product for automatic remote verification of identity documents”, filed on Nov. 21, 2019, the disclosure of which application/s is hereby incorporated by reference.

### FIELD OF THIS DISCLOSURE

The present invention relates generally to image processing and more particularly to systems for identifying authentic documents.

### BACKGROUND FOR THIS DISCLOSURE

Digital forgery (or digital tampering) is known.

A 2013 review of tamper detection techniques sadly admits that “It has become quite impossible to say whether a photograph is a genuine camera output or a manipulated version of it just by looking at it. As a result, photographs have almost lost their reliability and place as proves of evidences in all fields. This is why digital image tamper detection has emerged as an important research area to establish the authenticity of digital photographs by separating the tampered lots from the original ones”. (see https://www.researchgate.net/publication/243458359_Digital_Image_Tamper_Detection_Techniques_—A_Comprehensive_Study).

The above review explains that “Digital image tamper detection techniques can be broadly classified into two groups such as active detection techniques and passive (blind) techniques. The active techniques require a pre-processing step and suggest embedding of watermarks or digital signatures to images so as to authenticate them” which is not always practical, nor is it always effective. The passive methods neither require any prior information about the image nor necessitate the pre embedding of any watermark or digital signature into the image, and instead assume that “though the carefully performed digital forgeries do not leave any visual clue of alteration, they are bound to alter the statistical properties of the image” thereby to allow either “copy-move forgery detection or cloning and splicing” detection. There are also apparently techniques for detection based on “examining the lighting environment, camera feature based detections, studying the statistical and geometric properties”.

Prior art publications may assume there is a trusted entity which does have access to the original documents. (e.g. https://patents.google.com/patent/US8914898B2/en or https://patents.google.com/patent/WO2009098706A3/en) which is excellent if true, but is typically not factually true.

For example, electronic notarization of scanned documents is known (e.g. https://patents.google.com/patent/EP1710742A1/n1).

Or, authorities implicitly make the assumption that all is well. For example: “as long as your digital duplicates are the same as the original (which with the proper processes and procedures they would be), you can utilize them in U.S. Federal Courts and the majority of state courts.” (https://www.piftechnologies.com/scanned-documents-legally-accepted/), is a statement which avoids the issue of how, technically speaking, the courts could possibly ascertain whether or not “the proper processes and procedures” had been used.

Idcheck.io is a web service which remotely verifies identity documents.

KYC (know your customer) is prevalent, however, as Wikipedia notes, “Know your customer places an incredible costly burden on businesses operating in the financial industry, especially smaller financial companies where compliance costs are disproportionately heavy” and “Customers may feel the information requested to be extremely intrusive and burdensome”. Remote KYC is even more difficult than in-person KYC, but is a necessity, since consumer visits to retail bank branches are dropping, whereas the proportion of mobile transactions is rising.

Document frauds are described in this document: https://www.icao.int/meetings/mrtd-zimbabwe2012/documents/2-11-esteves_portugal-forensic. pdf.

Document verification methods are described in U.S. 20060157559 to Levy et al.

The following publication:

https://legal.thomsonreuters.com/en/insights/articles/synthetic-identity-fraud describes that “synthetic identity fraud (SIF), a relatively new form of identity theft in which criminals combine pieces of real personal data with fake information to create an entirely new identity, one that's almost impossible to trace . . . perpetrators of SIF start with a single piece of legitimate personal data—usually a Social Security number—and build a fake identity around it, using a bogus address, phone number, and other basic information. Fraudsters then use the fictitious identity to open lines of credit, secure auto loans, or scam government agencies in order to intercept tax returns and benefits payouts.”

Also, “efforts to digitize almost all financial transactions, including government benefits, have created both temptation and opportunity for cyber-thieves. It's much easier to impersonate someone online than it is in person, especially if the “person” exists only as a collection of data points. Banking, credit, and government agencies only check a few key pieces of data to establish a person's identity, and thieves are adept at mimicking them.

EP1964075A1 describes a method of creating a classifier for “media validation”. Banknotes are a main focus, however “any of the issues mentioned above also apply to validation of other types of valuable media such as passports”. The document states that “Information from all of a set of training images from genuine media items only is used to form a segmentation map which is then used to segment each of the training set images. Features are extracted from the segments and used to form a classifier which is preferably a one-class statistical classifier. Classifiers can be quickly and simply formed for different currencies and denominations in this way and without the need for examples of counterfeit media items.”

arxiv.org (https://arxiv.org/pdf/1910.08993.pdf) states that “Counterfeit detection has traditionally been a task for law enforcement agencies, see section EUROPOL and INTERPOL central offices are combating document and banknote counterfeiting [1, 2]. They have destined millions of euros in funds to provide technical databases, forensic support, training and operational assistance to its member countries . . . . There are many different strategies used to fake an ID like the alteration of a real passport, impersonation of the legitimate owner or printing false information on a stolen blank real paper, to cite some. Making a fake passport is easy, making a good fake passport is very, very hard. Probably there are few criminal organizations in the world which can produce a counterfeit visa or passport good enough to fool professional passport control.”

However, according to Arxiv, “There is no public available datasets for counterfeit detection in IDs and banknotes. This leads to every researcher to build their own private datasets where it will extract some results that in most cases nobody would be able to reproduce. Also the difficulty of creating these datasets to gather both genuine and counterfeit samples makes that each private dataset which generally contains few samples.” An example is given of a dataset “collected on the street including new and worn out banknotes”. Arxiv goes on to say that “Building a counterfeit dataset per se represents a difficult task due the scarcity nature of counterfeit documents. Usually a counterfeit dataset contains a small percentage of counterfeits compared with their genuine counterpart. Counterfeit datasets are usually collected by documents experts, see section 3. Training a document expert is expensive, hence generating a dataset generated by them represents a big economical effort. Most private companies in document security analysis can afford to invest in the generation of counterfeit datasets, however making these datasets public does not play in its own interests. On the other hand, even having the economical means and the predisposition of building a public dataset, is difficult to publish it as a benchmark for the research community”.

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented as appropriate.

Certain embodiments seek to provide a fully remote ID verification system and process that enables new customers to be on-boarded, either stand-alone or in conjunction with other remote ID verification system components such as videoconference KYC and/or Biometric verification.

Certain embodiments seek to provide a system, method and computer program product for automatic remote verification of identity documents.

An advantage of embodiments herein is convenience, both at the server end and at the client end, relative to other (cumbersome at the server end, and intrusive at the client end) remote KYC options such as videoconference KYC and/or Biometric verification. The system and process herein significantly reduces the risk of forgery/fraud by easily identifying certain prevalent forged document images.

It is appreciated that any reference herein to, or recitation of, an operation being performed, e.g. if the operation is performed at least partly in software, is intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention typically includes at least the following embodiments:

Embodiment 1. A system for differentiating “legitimate” images generated by scanning physical documents from “forged” document images at least partly generated by a graphics editor rather than by scanning a physical document, the system comprising:

a trained classifier, which may be implemented in a hardware processor which typically includes logic/circuitry configured to sort a stream of incoming images into, say, two classes which may include:
a first (“legitimate”) class of images which may be generated by scanning physical documents; and/or
a second (“forged”) class of images including images which may be at least partly generated by a graphics editor rather than by scanning a physical document; and/or
an output device operative to present, to an end-user, an output identifying, for at least one image I, whether the image I belongs to the first class or the second class; and/or
an output device configured, responsive to classifications generated by the trained classifier, to provide an output indication of whether each of plural images is generated by scanning a physical document, or is at least partly generated by a graphics editor. This output indication may be useful, inter alia, to any online entities or digital service providers who use remotely presented and/or remotely captured identity documents e.g. driving licenses or passports, for authentication of end-users such as but not limited to banks, online gambling, airlines, car rental facilities, hotels.

It is appreciated that an image can be only partly generated by a graphics editor e.g. if one region of the image was generated by, say, Adobe Photoshop or some other graphics editor, and another region of the same image is a portion of a digital image generated by scanning a physical document. An image entirely generated by a graphics editor may be termed “synthetic” or entirely synthetic, whereas an image only partly generated by a graphic editor may be termed “partly synthetic”.

The output device may comprise a computer screen display, printer, speaker or any other suitable peripheral of a computerized system capable of presenting information to an end-user.

Each image may comprise, say, a pixel map or a JPEG, image or any other digital representation of a document.

Embodiment 2. A system according to any of the preceding embodiments wherein the classifier is trained on a training set of labelled images including:

a first set (e.g. first subset of the training set) of labelled images, known to have been generated by scanning a physical predecessor e.g. a physical document, wherein labels of each image in the first set indicates membership in the first class.

Embodiment 3. A system according to any of the preceding embodiments wherein the documents comprise ID documents.

Embodiment 4. A system according to any of the preceding embodiments wherein the classifier comprises a neural network.

The classifier typically includes a binary classifier classifying images as either legitimate or forged.

Backpropagation may be used to train a (typically multi-layered) neural network to learn the mapping of input (e.g. image) to output (e.g. label) represented by the training set. Typically, during training, the network is configured to, at least once, make a guess about data (e.g. is image x legitimate or forged), using the network's current parameters e.g. internal weights, the network's guess is measured with a loss function thereby to define an error, and the error is backpropagated to adjust the (direction and/or magnitude of) the current parameters. Backpropagation adjusts the neural network's parameters in the direction of less error. Any optimization technique may be used to modify internal weights of neural networks in order to minimize the loss function e.g. genetic algorithms, greedy search, brute-force search, or weight optimization using differentiation. Deep learning frameworks, e.g. TensorFlow, may be used to set deep neural networks, using suitable lines of code. Deep learning platforms e.g. MissingLink may be used to run and manage deep learning experiments.

It is appreciated that the classifier need not employ a neural network, and alternatively may employ any other suitable machine learning technique such as Logistic Regression, Decision Tree Algorithm, Random Forest Algorithm, Naive Bayes Classifier, k-Nearest Neighbor.

Embodiment 5. A system according to any of the preceding embodiments wherein the second (“forged”) class of images includes at least some images entirely generated by a graphics editor.

Embodiment 6. A system according to any of the preceding embodiments wherein the hardware processor is deployed remotely relative to, and/or lacks physical access to, the physical documents.

Embodiment 7. A system according to any of the preceding embodiments wherein the second (“forged”) class of images includes only images entirely generated by a graphics editor.

Embodiment 8. A system according to any of the preceding embodiments wherein the training set also includes a second set (e.g. second subset of the training set) of labelled images known to have been at least partly generated by a graphics editor rather than by scanning a physical document, wherein labels of each image in the second set indicates membership in the second class.

Embodiment 9. A method for classifying documents, the method comprising:

training a classifier, residing on a hardware processor, on a training set including images generated by scanning physical documents, and images at least partly generated by a graphics editor, thereby to provide a trained classifier;

providing a sequence of images which includes images generated by scanning legitimately physical documents and images at least partly generated by a graphics editor, and using the trained classifier to generate classifications which differentiate the legitimately generated images from the images at least partly generated by a graphics editor; and

responsive to classifications generated by the trained classifier, providing, for at least some images in the sequence, an output indication of whether each of the some images is generated by scanning a physical document, or is at least partly generated by a graphics editor.

Embodiment 10. A computer program product, comprising a non-transitory tangible computer readable medium having computer readable program code embodied therein, the computer readable program code adapted to be executed to implement a method for classifying documents, the method comprising:

training a classifier, residing on a hardware processor, on a training set including images generated by scanning physical documents and images at least partly generated by a graphics editor, thereby to provide a trained classifier;

providing a sequence of images which includes images generated by scanning legitimate physical documents and images at least partly generated by a graphics editor, and using the trained classifier to generate classifications which differentiate the legitimately generated images from the images at least partly generated by a graphics editor; and

responsive to classifications generated by the trained classifier, providing, for at least some images in the sequence, an output indication of whether each of the some images is generated by scanning a physical document, or is at least partly generated by a graphics editor.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general purpose computer specially configured for the desired purposes by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g. BLE) or wired (e.g. USB)), a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may for example comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs) or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein which may for example include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “UI” as used herein includes also the underlying logic which controls the data presented to the user e.g. by the system display and receives and processes and/or provides to other modules herein, data entered by a user e.g. using her or his workstation/device.

### BRIEF DESCRIPTION OF THE DRAWINGS

Example embodiments are illustrated in the various drawings. Specifically:

FIG. 1 is a simplified flowchart illustration of a method which may be performed by a suitably configured hardware processor, suitably configured in accordance with certain embodiments of the invention.

Certain embodiments of the present invention are illustrated in the following drawings; in the block diagrams, arrows between modules may be implemented as APIs and any suitable technology may be used for interconnecting functional components or modules illustrated herein in a suitable sequence or order e.g. via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g. as shown. Tables herein may include all or any subset of the fields and/or records and/or cells and/or rows and/or columns described.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit technology), or any combination thereof.

Functionality or operations, stipulated as being software-implemented, may alternatively be wholly or fully implemented by an equivalent hardware or firmware module, and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include, within the scope of the embodiments of the present invention, also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes, or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper, and others.

### DETAILED DESCRIPTION OF CERTAIN EMBODIMENTS

Certain embodiments seek to provide a method for differentiating between legitimate images, generated by scanning authentic physical documents and transmitting the scan electronically to a remote processor, and illegitimate images which are synthesized from scratch, e.g. by forgers, and typically have no physical precursor at all, as opposed to tampered documents which have a physical precursor, typically authentic, which is tampered with, either before scanning, or after (by digitally altering the scanned authentic image e.g. to replace one or more elements in the document, such as the document bearer's name, photograph or birth-date. Thus, this method advantageously tackles a phenomenon enabled by the Internet age—a new and worrisome new type of forgery in which portions of documents, or entire false documents, aka synthetic documents, are generated digitally, often by (illegal) web services. These synthetic documents then need to be distinguished, remotely, from legitimate images, generated by scanning authentic physical documents.

The method typically includes identifying documents which are “too perfect”, or have too high a level of contrast, as synthetic documents.

Images herein referred to as “forged” or “synthetic” may include document images created from scratch by a counterfeiter with or without reference to an existing identity document template, counterfeit images generated by reproducing an identity document in full, scrubbed document images, a personalized image of a stolen blank document, and partially synthetic document images, in which less than all of the previous document image (e.g. just the birthdate) is changed by the forger.

It is appreciated that a first set of labelled images, known to have been generated by scanning a physical predecessor e.g. a physical document, is easy to come by, since any scanned images of, say passports or driving licenses or other identity documents, from any countries, may be employed.

However, it is also possible to generate a second set of labelled images known to have been at least partly generated by a graphics editor rather than by scanning a physical document, even given it is not possible to find a human expert having the ability to identify such documents, without having observed the documents being generated. For example, there are web services which openly supply forged e.g. synthetic passports such as, for example: http://www.worldlegitdocument.com/buy-drivers-license-online/ which urges those who visit the site to “buy Driver's License Online”, adding that “We give both Real and curiosity archives like Id cards, travel papers, visas, Fake Driver License For Sale, IELTS, GMAT, secondary school recognition, green cards, occupant grants, universal driver's permit, global work grant and numerous different records. For the Real Id Cards and Driver's License, we register all the data into the database framework and if the ID card or driver's permit is checked utilizing an information perusing machine, all your data will appear in the framework and you will legitimately utilize the record. We additionally give Id cards which are only the equivalent with the genuine ID and driver's permit. Be that as it may, none of the data on the archive will be enlisted . . . We are the world number one arrangement of records online like travel papers, buy IELTS certificate online, id cards, green cards, visas, inhabitant licenses, IELTS, GMART and numerous different reports for the entire world.

We inform anyone who needs any sort regarding reports to look through no more once you discover us. We are the best and extraordinarily supplier of any sort of records on the planet; we work with insiders in the administration in various nations and you don't have to visit any nation before you can get its documents or gets its nationality.”

At the following link https://www.dailymotion.com/video/x62rw53, an obliging forger undertakes to “design or edit” any of the following: “Driver License, ID Cards, Passports, SSN Cards”, using “Photoshop or Illustrator”, and giving his contact particulars including Skype, Whatsapp, Facebook, email and ICQ.

This link: https://www.peopleperhour.com/hire-freelancers/photoshop+driving+license lists 19,322 “Freelancers . . . for photoshop driving license” who can be hired.

This link: https://www.fivesquid.com/43741/edit-any-document- - -id-passport-ticket-diploma-driving-license-certificate-utility-bill-etc advertises a forger who promises to “professionally edit: IDs/Passport/Tickets/Diplomas/Driving License/Certificates/Utility Bills/Any Document” adding that he will “only provide the editing, you are responsible for if or how you use of them”.

Alternatively, or in addition, images for a second set may be provided using captured files, in view of the fact that enforcement authorities sometimes discover forger premises at which computerized systems storing synthetic (forged) documents are captured.

Alternatively or in addition, images for the second set may be provided when web services receive images, which are clearly eligible for the second set, e.g. because the images arrive with exif metadata (typically describing file properties) whose software field indicates a graphics editor, say, “Adobe Photoshop” rather than indicating a scanner (or cellphone camera)—e.g. because the forger was not sophisticated enough to doctor the exif metadata's software field by replacing the indication of the graphics editor that was actually used, with a false indication of a scanner (or cellphone camera). Exif is an example of an Exchangeable image file format used to stipulate formats for images inter alia used by smartphone cameras inter alia.

Alternatively or in addition, various image/s of document/s may be known to be eligible for the second set because their metadata (e.g. exif) (typically describing file properties) indicates a geo-location, say in Poland, for a non-Polish end-user or for plural end-users, each of which actually hail from various geo-locations e.g. various cities in the USA. Thus the document images, ostensibly belonging to the various American end-users, are all in fact synthetic documents forged in Poland.

Alternatively or in addition, images for the second set may be provided by using graphic editors such as Adobe Photoshop to generate synthetic documents. For example, images for the second set may be generated by using public domain tutorials on how to forge a driving license using suitable software such as Photoshop. For example, using the Google search engine to search a suitable string such as driving license Photoshop, yields a plethora of search results, including: https://www.youtube.com/watch?v=tazVHHzR81E which describes how to use software to “edit . . . a driving license”, https://www.dailymotion.com/video/x320a7s on “HOW TO CREATE A FAKE ID IN PHOTOSHOP”; and https://docs.google.com/document/d/1n6-cO8cOWkOKizK1yZU2NceXit7DWtbJ1aVh8ARfSbE/edit which describes “How to edit a driver license in Photoshop” also, https://hubpages.com/art/photoshop-lesson3 explains that “This lesson will show you how to edit an image of your ID card or documents that you may want to alter . . . Changing the date of birth and photo is actually very simple in most cases, in this case we will use an image of a sample NY State Drivers license . . . . Step By Step:

Step 1: With Photoshop open on your computer, go to “file” in the top right corner, then scroll down and click “open”, then browse through your computer and select the image you intend to edit or alter.
Step 2: Use the magnification tool on the bottom left of the menu (looks like a magnifying glass) and zoom in on the date of birth.
Step 3: In this case the original date of birth is Jun. 9, 1985, we will simply use the rectangular marquee tool on the top left of the menu (looks like a little square) to copy the “6”, simply place a square just covering the area of the 6. click ctrl C, then ctrl V.
Step 4: Now you should have a copy of the number “6”. use the move tool on the top of the left menu to slide the “6” over and completely cover the “8”, now we have a date of birth in the year 1965, as apposed to 1985. You can imagine how this might be useful?
Step 5: If you only intended to change the date of birth, then you are finished and you can skip to step 7, however if you want to edit the name or address you can use the same process and continue moving numbers or letters around. You will be limited to the characters you have to work with, but in most cases this will be enough to slightly change name and address. For example, you can change 1043 front st, to 1430 fort st.
Step 6: If you intend to change a photo of an ID, in some cases you can simply paste a photo of the same size and similar background as I have done in this example. If it is not going to be that simple, you can see my article on face swapping: http://hubpages.com/hub/Photoshop-lesson2
Step 7: When your image is complete, I suggest you print it out, then scan it and save it as a scan, this makes it look more authentic and takes away evidence of tampering.”

Thus images for the second set may be generated by using steps 1-6 without step 7.

It is appreciated that some forged images e.g. images generated by using steps 1-7 above, may be mis-classified by the system shown and described herein, however the system is nonetheless greatly advantageous in detecting a large number of forgeries, although not all forgeries, present in a typical stream of incoming images to, say, a web service or other networked enterprise which, typically in order to remotely know their end-users (remotely conducted “Know Your Customer”, aka KYC), require electronic presentation of documents such as online gambling services, financial organizations trying to identify end customers who seek to open a new account, Fintech enterprises, collaboration platforms, transfers.

Or, https://www.wikihow.com/Design-an-ID-Card-Using-Adobe-Photoshop explains “How to Design an ID Card Using Adobe Photoshop”, diplomatically admonishing end-users that they should not “use this to make forged ID's. This is illegal and you could get arrested for doing so”, but describing step 1 which is “obtain the software program Adobe Photoshop” followed by:

“Image titled Design an ID Card Using Adobe Photoshop Step 2
Start a new image the size of the ID. ID's are 3.375 inches (8.6 cm) wide by 2.125 inches (5.4 cm) tall. From the File menu click New. Change the units drop down menu from pixels to inches. In the width box type 3.375 and in the height box type 2.125. Depending on the quality of the images you plan to use on your ID, you may want to increase the resolution to 200 to 301 pixels/inch. While increasing the resolution will make the ID appear larger on your screen, its printed size will remain the same.
Image titled Design an ID Card Using Adobe Photoshop Step 3
Find your ID background image. Your company/club logo or a stock photo will work. Fill your background layer with the color white. Copy and paste your background image to a new layer above this and decrease the opacity (found in the menu above the layers) until you have the desired look. To change the size of the background image, click the image layer and click the Edit menu (next to the File menu) and select Free Transform (or use the shortcut Control+T). Click and drag the edges to the size you desire.
Image titled Design an ID Card Using Adobe Photoshop Step 4
Import the person's photo. Using the same methods from step 2, copy and paste the person's facial image onto the ID and use Free Transform to change it to the right size. If you want your ID to have a “ghost image” of the person's face you can copy and paste a second facial image onto the ID, use Free Transform (Control+T) to make it smaller, and change its opacity to make it more transparent.
Image titled Design an ID Card Using Adobe Photoshop Step 5
Add their personal information and signature. Use the text tool to add the personal information. If you want to add a realistic looking signature you will have to download a signature font online and install it before being able to use it.

### Question

How do I find the same size lettering as a driver's license to print off?

### Community Answer

You can put a ruler up to the screen to measure the lettering, or just use trial and error.

### Tips

For additional information on how to find and install new fonts, which is good for using as a signature on your ID card, read the Wikihow article Install Fonts on Your PC.”.

According to certain embodiments, the second set of labelled images includes a mix of both synthetic (aka “entirely synthetic”) and partly synthetic documents. Typically, whether or not there is a mix, and what is the ratio of entirely vs partly synthetic, need not be known.

According to certain embodiments, the second set of labelled images includes only entirely synthetic documents.

Alternatively or in addition, the first and/or second sets of labelled images may each include a mix of document images e.g. images of ID documents of various types (driving license, passport) etc., from various series, and/or from various countries. The label of each image typically only indicates whether the image is a member of the first or second classes of images defined herein, and typically does not indicate the type of ID document or country of issuance. Also, typically, it is not necessary to image-process the documents in the first and/or second set, or the images in the stream of incoming images, to determine the type of ID document, or country of issuance.

Training a classifier, then, using the trained classifier as described herein, may be replaced by identifying features which differentiate the two classes, and configuring a processor accordingly. For example, images in the first “genuine” class may be differentiated from images in the second, “synthetic” class, because the former have more variation within blocks of solid color, due to artifacts of the printer used to generate the predecessor document, and/or due to artifacts of the scanner (or cellphone camera) used to scan the predecessor. In contrast, the latter may have little or no variation between blocks of solid color e.g. all pixels within a black eagle are homogeneous (exactly the same black), in the second class, but not in the first class. Or, shininess may occur e.g. in specific locations, in the first genuine class, but may not occur in images belonging to the second, synthetic class. It is appreciated that shininess may be detected in an image document e.g. as described in co-owned published pct patent application WO2016005968A3, entitled “System and method for quantifying reflection e.g. when analyzing laminated documents”, the disclosure of which is incorporated herein by reference, as are all other publications mentioned herein.

It is appreciated that a classifier may be trained to classify into one class or category from among any set of the categories described in https://www.icao.int/meetings/mrtd-zimbabwe2012/documents/2-11-esteves_portugal-forensic.pdf. For example, a classifier may be trained to classify documents as either genuine or counterfeit, or either genuine or forged, or either genuine or fraudulent, or either genuine or pseudo-document. Or, the classifier may be trained to classify documents into more than 2 categories or classes e.g. either genuine, or counterfeit, or forged, or fraudulent, or pseudo-document. Or, documents may be classified inter alia into more than one class of fraudulent documents e.g. those provided with internal help and those provided without. Or, documents may be classified inter alia into more than one class of pseudo-documents e.g. fantasy, camouflage or fictitious. The classifier may be trained using a training set which includes labelled examples of various of the above types of documents (e.g. labelled genuine documents, labelled forged documents, labelled fictitious documents, etc.).

It is appreciated that any source of non-authentic documents may be defined as a class, such as documents collected from a given law enforcement entity or digital service provider, or documents provided by various service providers openly offering their services to generate non-authentic documents, on the Internet e.g. via social networks. Alternatively or in addition, the source itself may subdivide its own non-authentic documents e.g. a law enforcement agency may subdivide its own collected non-authentic documents by type and/or by geographic region and/or by the time period during which the document was collected.

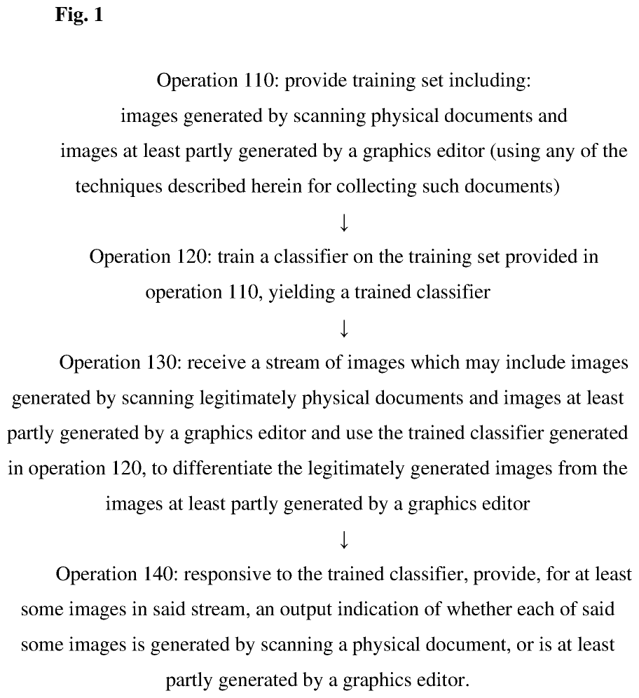

FIG. 1 is a simplified flow of a method according to certain embodiments, which includes all or any subset of the following operations, all of any subset of which may be performed by a hardware processor, suitably ordered e.g. as shown:

Operation 110: provide training set including:

images (e.g. of identity documents from various countries) known to have been (and labelled as having been) generated by scanning physical documents and images (e.g. of identity documents from various countries) known to have been (and labelled as having been) “forged” e.g. at least partly generated by a graphics editor (using any of the techniques described herein for collecting such documents)

Operation 120: train a (typically binary) classifier on the training set provided in operation 110, yielding a trained classifier

Operation 130: receive a stream of images which may include images (e.g. of identity documents from various countries) generated by scanning physical documents and images (e.g. of identity documents from various countries) “forged” e.g. at least partly generated by a graphics editor, and use the trained classifier generated in operation 120, to differentiate the legitimately generated images from the illegitimately forged images.

Operation 140: responsive to the trained classifier, provide, for at least some images in the stream, an output indication of whether each of the some images is generated by scanning a physical document, or is at least partly generated by a graphics editor.

It is appreciated that terminology such as “mandatory”, “required”, “need” and “must” refer to implementation choices made within the context of a particular implementation or application described herewithin for clarity, and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a network—e.g. web-based system employing software, computers, routers and telecommunications equipment, as appropriate.

Any suitable deployment may be employed to provide functionalities e.g. software functionalities shown and described herein. For example, a server may store certain applications, for download to clients, which are executed at the client side, the server side serving only as a storehouse. Any or all functionalities e.g. software functionalities shown and described herein may be deployed in a cloud environment. Clients, e.g. mobile communication devices such as smartphones, may be operatively associated with, but external to, the cloud.

The scope of the present invention is not limited to structures and functions specifically described herein, and is also intended to include devices which have the capacity to yield a structure, or perform a function, described herein, such that even though users of the device may not use the capacity, they are if they so desire able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g. triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous given the state or condition or data, and/or may prevent at least one outcome which is disadvantageous given the state or condition or data. Alternatively or in addition, an alert may be provided to an appropriate human operator or to an appropriate external system.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art, and, particularly although not limited to those described in the Background section or in publications mentioned therein.

Conversely, features of the invention, including operations, which are described for brevity in the context of a single embodiment or in a certain order, may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

Any suitable communication may be employed between separate units herein e.g. wired data communication and/or in short-range radio communication with sensors such as cameras e.g. via WiFi, Bluetooth or Zigbee.

It is appreciated that implementation via a cellular app as described herein is but an example and instead, embodiments of the present invention may be implemented, say, as a smartphone SDK; as a hardware component; as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network, or is tethered directly or indirectly/ultimately to such a node).

Any operation or characteristic described herein may be performed by another actor outside the scope of the patent application and the description is intended to include any apparatus, whether hardware, firmware or software, which is configured to perform, enable or facilitate that operation or to enable, facilitate or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry including any such computer microprocessor/s, as well as in firmware or in hardware, or any combination thereof.

It is appreciated that elements illustrated in more than one drawings, and/or elements in the written description may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations or functionalities described herein which are, for clarity, described in the context of separate embodiments, may also be provided in combination in a single embodiment, except where the specification or general knowledge specifically indicates that certain teachings are mutually contradictory and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element e.g. operation described herein may have all characteristics and attributes described or illustrated herein, or according to other embodiments, may have any subset of the characteristics or attributes described herein.

It is appreciated that end-users seeking to present documents for authentication may be equipped with an app such as a cell app, mobile app, computer app or any other application software. Any application may be bundled with a computer and its system software, or published separately. The term “cell” or “phone” and similar used herein, is not intended to be limiting, and may be replaced or augmented by any device having a processor, such as but not limited to a mobile telephone, or also set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network, or is tethered directly or indirectly/ultimately to such a node). Thus the computing device may even be disconnected from e.g., WiFi, Bluetooth etc., but may be tethered directly or ultimately to a networked device.

1. A system for differentiating “legitimate” images generated by scanning physical documents from “forged” document images at least partly generated by a graphics editor rather than by scanning a physical document, the system comprising:
a trained classifier, implemented in a hardware processor which includes logic/circuitry configured to sort a stream of incoming images into two classes including:
a first (“legitimate”) class of images generated by scanning physical documents; and
a second (“forged”) class of images including images at least partly generated by a graphics editor rather than by scanning a physical document; and
at least one of:
an output device operative to present, to an end-user, an output identifying, for at least one image I, whether said image I belongs to said first class or said second class; and
an output device configured, responsive to classifications generated by the trained classifier, to provide an output indication of whether each of a plural of images is generated by scanning a physical document, or is at least partly generated by a graphics editor.

2. A system according to claim 1 wherein said classifier is trained on a training set of labelled images including:
a first set (e.g. first subset of said training set) of labelled images, known to have been generated by scanning a physical predecessor e.g. a physical document, wherein labels of each image in said first set indicates membership in said first class.

3. A system according to claim 1 wherein said documents comprise ID documents.

4. A system according to claim 1 wherein said classifier comprises a neural network.

5. A system according to claim 1 wherein said second (“forged”) class of images includes at least some images entirely generated by a graphics editor.

6. A system according to claim 1 wherein the hardware processor is deployed remotely relative to, and/or lacks physical access to, the physical documents.

7. A system according to claim 1 wherein said second (“forged”) class of images includes only images entirely generated by a graphics editor.

8. A system according to claim 1 wherein the training set also includes a second set of labelled images known to have been at least partly generated by a graphics editor rather than by scanning a physical document, wherein labels of each image in said second set indicates membership in said second class.

9. A method for classifying documents, the method comprising:
training a classifier, residing on a hardware processor, on a training set including images generated by scanning physical documents, and images at least partly generated by a graphics editor, thereby to provide a trained classifier;
providing a sequence of images which includes images generated by scanning legitimately physical documents and images at least partly generated by a graphics editor, and using the trained classifier to generate classifications which differentiate the legitimately generated images from the images at least partly generated by a graphics editor; and
responsive to classifications generated by the trained classifier, providing, for at least some images in the sequence, an output indication of whether each of said some images is generated by scanning a physical document, or is at least partly generated by a graphics editor.

10. A computer program product, comprising a non-transitory tangible computer readable medium having computer readable program code embodied therein, said computer readable program code adapted to be executed to implement a method for classifying documents, the method comprising:
training a classifier, residing on a hardware processor, on a training set including images generated by scanning physical documents and images at least partly generated by a graphics editor, thereby to provide a trained classifier;
providing a sequence of images which includes images generated by scanning legitimate physical documents, or legitimately generated images, and images at least partly generated by a graphics editor, and using the trained classifier to generate classifications which differentiate the legitimately generated images from the images at least partly generated by a graphics editor; and
responsive to classifications generated by the trained classifier, providing, for at least some images in the sequence, an output indication of whether each of said some images is generated by scanning a physical document, or is at least partly generated by a graphics editor.
